(19) United States
(12) Patent Application Publication
(10) Pub. No.: US 2026/0161820 A1
(43) Pub. Date: Jun. 11, 2026

(54) ASSISTING A USER TO OPT-OUT FROM PERSONAL INFORMATION USAGE BY THIRD PARTIES

(71) Applicant: PrivacyHawk, Inc, Los Angeles, CA (US)

(72) Inventors: Aaron MENDES, San Diego, CA (US); Justin WRIGHT, Los Angeles, CA (US)

(21) Appl. No.: 18/974,678

(22) Filed: Dec. 9, 2024

(51) Int. Cl. G06F 21/62

(52) U.S. Cl. CPC G06F 21/6245

(57) ABSTRACT

In an aspect, an apparatus receives, from a service provider, an opt-out response to an opt-out request for an opt-out process, wherein the opt-out response includes natural language text indicating a response to the opt-out request, determines, based on the natural language text indicating the response to the opt-out request, that additional information, additional actions, or a combination thereof are needed to complete the opt-out process, applies a first machine learning model to the natural language text indicating the response to the opt-out request to generate executable code to input the additional information, perform the additional actions, or the combination thereof, and executes the executable code to input the additional information, perform the additional actions, or the combination thereof.

### TECHNICAL FIELD

Aspects of the disclosure relate generally to increasing the privacy of a user's personal information, and more specifically, to assisting a user to opt-out of having their personal information stored and used by third parties.

### BACKGROUND

With the ever-increasing use of the internet to interact with customers and/or clients, businesses are collecting and storing more personal information about their customers and clients than ever before. Many of these businesses then share, sell, or otherwise expose that personal information without their customers' and/or clients' knowledge. Additionally, even well-meaning businesses can suffer a data breach, exposing sensitive personal information of their customers to hackers and cybercriminals. While new laws have been enacted to help prevent these problems, or at least to allow their customers and/or clients to opt-out from such collection, sharing, and exposure, it is nearly impossible for customers and clients to take advantage of their privacy rights due to complicated opt-out processes and the sheer number of companies exploiting their personal information. Even where a customer or client does submit an opt-out request to a company, it may not be clear whether that opt-out was successful, given that opt-out procedures and opt-out confirmations can vary dramatically from company to company.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method for completing an opt-out process performed by an apparatus includes receiving, from a service provider, an opt-out response to an opt-out request for the opt-out process, wherein the opt-out response includes natural language text indicating a response to the opt-out request; determining, based on the natural language text indicating the response to the opt-out request, that additional information, additional actions, or a combination thereof are needed to complete the opt-out process; applying a first machine learning model to the natural language text indicating the response to the opt-out request to generate executable code to input the additional information, perform the additional actions, or the combination thereof; and executing the executable code to input the additional information, perform the additional actions, or the combination thereof.

In an aspect, an apparatus includes one or more memories; one or more transceivers; and one or more processors communicatively coupled to the one or more memories and the one or more transceivers, the one or more processors, either alone or in combination, configured to: receive, via the one or more transceivers, from a service provider, an opt-out response to an opt-out request for the opt-out process, wherein the opt-out response includes natural language text indicating a response to the opt-out request; determine, based on the natural language text indicating the response to the opt-out request, that additional information, additional actions, or a combination thereof are needed to complete the opt-out process; apply a first machine learning model to the natural language text indicating the response to the opt-out request to generate executable code to input the additional information, perform the additional actions, or the combination thereof; and execute the executable code to input the additional information, perform the additional actions, or the combination thereof.

In an aspect, an apparatus includes means for receiving, from a service provider, an opt-out response to an opt-out request for the opt-out process, wherein the opt-out response includes natural language text indicating a response to the opt-out request; means for determining, based on the natural language text indicating the response to the opt-out request, that additional information, additional actions, or a combination thereof are needed to complete the opt-out process; means for applying a first machine learning model to the natural language text indicating the response to the opt-out request to generate executable code to input the additional information, perform the additional actions, or the combination thereof; and means for executing the executable code to input the additional information, perform the additional actions, or the combination thereof.

In an aspect, a non-transitory computer-readable medium stores computer-executable instructions that, when executed by an apparatus, cause the apparatus to: receive, from a service provider, an opt-out response to an opt-out request for the opt-out process, wherein the opt-out response includes natural language text indicating a response to the opt-out request; determine, based on the natural language text indicating the response to the opt-out request, that additional information, additional actions, or a combination thereof are needed to complete the opt-out process; apply a first machine learning model to the natural language text indicating the response to the opt-out request to generate executable code to input the additional information, perform the additional actions, or the combination thereof; and execute the executable code to input the additional information, perform the additional actions, or the combination thereof.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example system for implementing the email opt-out and early data breach notification procedures described herein.

FIG. 2 illustrates an example opt-out procedure, according to aspects of the disclosure.

FIG. 3 illustrates an example neural network, according to aspects of the disclosure.

FIG. 4 is a diagram illustrating the use of a machine learning model to classify opt-out responses, according to aspects of the disclosure.

FIG. 5 is a block diagram illustrating various components of an example user device, according to aspects of the disclosure.

FIG. 6 is a block diagram illustrating various components of an example privacy server, according to aspects of the disclosure.

FIG. 7 illustrates an example method for completing an opt-out process, according to aspects of the disclosure.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As noted above, with the ever-increasing use of the internet to interact with customers and/or clients, service providers (e.g., retailers, utility companies, financial institutions, social media applications, non-governmental organizations, government entities, etc.) are collecting and storing more personal information about their customers and clients than ever before. Many of these service providers then share, sell, or otherwise exploit that personal information without their customers' and/or clients' knowledge. Additionally, even well-meaning service providers may fall victim to a data breach in which sensitive personal information of their users is leaked to hackers and scammers who can use that data to commit fraud, such as identity theft and phishing scams. While new laws have been enacted to help individual users remove these vulnerabilities, or at least to allow their customers and/or clients to opt-out from such collection, sharing, and exposure, it is nearly impossible for customers and clients to take advantage of their privacy rights due to complicated opt-out processes and the sheer number of service providers exposing and exploiting their personal information. Even where a customer or client does submit an opt-out request to a service provider, it may not be clear whether that opt-out was successful or whether additional steps are needed, given that opt-out procedures and opt-out confirmations can vary dramatically from service provider to service provider.

Accordingly, the present disclosure provides techniques to determine whether, and what, additional steps are needed to complete an opt-out request and then to perform those steps as needed. At a high level, a privacy application may perform an email inbox scan of a user's email account to identify service providers that likely have the user's personal information (also referred to as “first party data”). The user can then select some or all of the identified service providers and the privacy application will send opt-out requests to those companies. Based on a response from a service provider, the privacy application can determine whether the opt-out request was successful or, if not, determine what additional steps need to be performed. The privacy application can then perform those additional steps.

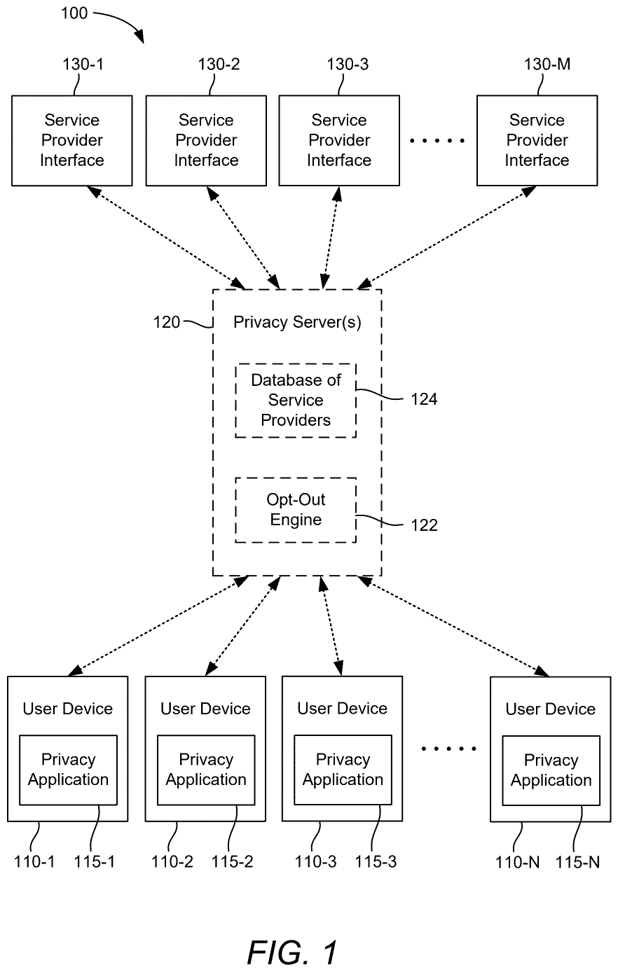

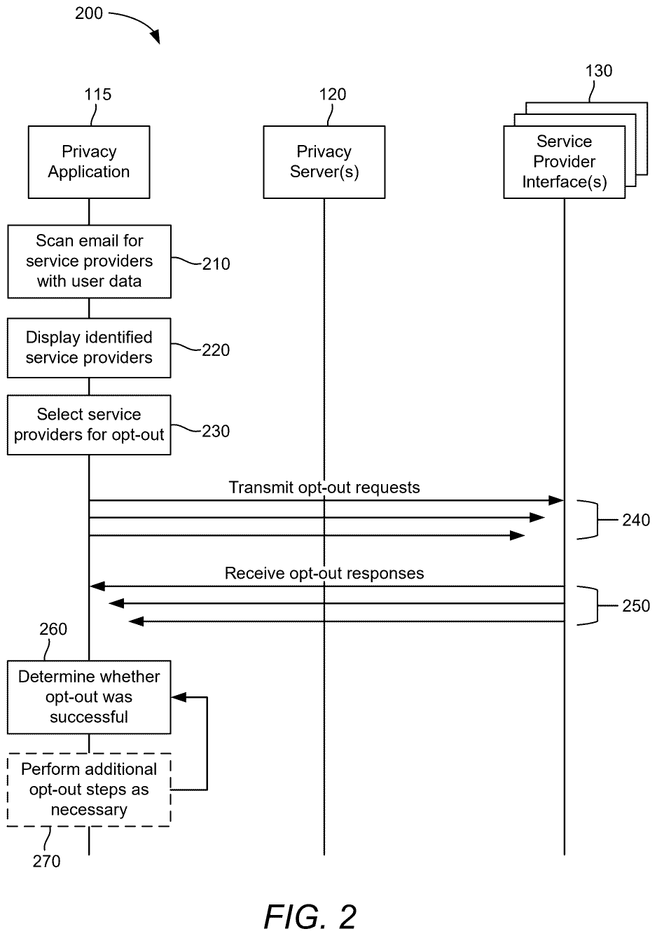

The email opt-out procedure is described with reference to FIGS. 1 and 2. Specifically, FIG. 1 illustrates an example system 100 for implementing the email opt-out procedures described herein, and FIG. 2 illustrates an example opt-out procedure 200, according to aspects of the disclosure.

As shown in FIG. 1, a plurality of N user devices 110 (illustrated as user devices 110-1, 110-2, 110-3, . . . 110-N) each have a privacy application 115 installed thereon (illustrated as privacy applications 115-1, 115-2, 115-3, . . . 115-N). A user device 110 may be a smartphone, a tablet computer, a laptop computer, a desktop computer, or the like. The N user devices 110 may optionally be in communication with a privacy server 120 (or a group of distributed privacy servers 120). The privacy server(s) 120 implement an opt-out engine 122 and store a database of service providers 124 (e.g., all known service providers, all service providers from which users have been known to opt-out, all service providers of given type(s), or the like). The privacy server 120 is in communication with a plurality of M service providers (e.g., retailers, utility companies, financial institutions, social media applications, organizations, government entities, etc.) that may store users' personal information (first party data). More specifically, a communication interface of the privacy server 120 may connect to communication interfaces of the service providers 130 over a wired and/or wireless network, such as the Internet, via websites, webservers, and/or the like associated with the service providers 130.

In some cases, rather than the privacy application 115 running locally on a user device 110, the privacy application 115 may run remotely on the privacy server(s) 120 (not shown in FIG. 1). In this case, the user may access the privacy application 115 via a website hosted by the privacy server(s) 120.

Many of the service providers with a user's first party data are likely to be found via the user's email account. For example, a service provider from which the user receives email at least has the user's email address, and likely has other personal information, such as at least name and gender. In many cases, these emails may be unsolicited and may include an “unsubscribe” link within the body of the email. A user may wish not only to unsubscribe from such emails, but also, to request that those service providers delete any personal information of the user they may store.

Accordingly, at stage 210 of FIG. 2, a privacy application 115 (optionally in communication with the opt-out engine 122) installed on a user device 110 scans the user's email inbox (including spam folder and deleted folder) for service providers that are likely to have the user's first party data. In some cases, this may be all the service provider email accounts/domains from which the user has ever received an email. In some cases, this may be all the sender email accounts/domains that match a service provider in the database of service providers 124. In this case, the privacy application 115 may securely provide a list of all email accounts/domains (or at least all commercial, governmental, educational, etc. email accounts/domains) found in the user's email to the opt-out engine 122, which may in turn compare that list to the service provides stored in the database of service providers 124. The opt-out engine 122 may then return to the privacy application 115 a list of service providers in the database of service providers 124 that matches the list of email accounts/domains received from the privacy application 115.

Based on the user's privacy preferences with respect to the user device 110 and/or email account (typically accessed via an email application), the user may need to grant the privacy application 115 permission to access the user's email account/application. In some cases, the user's email inbox (or at least a portion of the user's email inbox) may not be stored locally on the user device 110, but rather, on one or more remote email servers (not shown in FIG. 1 or 2). In those cases, the privacy application 115 may securely connect with the remote email server(s) to access the user's email account (e.g., via communication interfaces of the user device 110 and the remote email server(s)).

Once the user's email inbox has been scanned, at stage 220, the privacy application 115 may display a list of the identified service providers to the user via the user interface of the user device 110. The privacy application 115 may display a select button by each entry in the list of service providers identified at stage 210 to allow the user to select the corresponding service provider. The privacy application 115 may also recommend which service providers to select. For example, the privacy application 115 may display a list of “Recommended” service providers or highlight recommended service providers within the list of identified service providers. In some cases, the recommendations may be based on information from the privacy server(s) 120.

At stage 230, the privacy application 115 selects the service providers to which to send opt-out requests. The selection may be based on user input. For example, the user may select to opt-out of all identified service providers, only recommended service providers, only service providers of a certain type (e.g., retailers, political organizations, etc.), or the like. The user may further indicate the type of opt-out desired (i.e., the type of privacy right the user wishes to exercise), such as having all their first party data deleted, opting out of having their first party data shared with affiliates or other third parties, unsubscribing from promotional/marketing emails (often referred to as “spam”), requesting a copy of the data that the entity holds about the user (“right to know request”), and/or the like. Alternatively, the service providers and the type(s) of opt-out may be selected automatically or based on earlier user input. For example, when initiating the email scan at stage 210, the user may set a preference to opt-out from allowing any service provider to share the user's personal information. As will be appreciated, in the latter cases (i.e., automatic selection or earlier user selection), stage 220 would not be performed and stage 230 would be performed without user interaction.

At stage 240, the privacy application 115 transmits opt-out requests to the selected service providers (optionally via the privacy server 120/opt-out engine 122). Some service providers handle opt-out requests by email (i.e., a user is expected to compose and send an opt-out request to the service provider by email) and other service providers handle opt-out requests by webform (i.e., the user is expected to fill out an online form requesting the opt-out). An opt-out request is generally more effective if it comes directly from the user. Accordingly, for email-based opt-out requests, the privacy application 115 composes and sends, from the user's email account, emails requesting the types of opt-outs for the respective service providers. For webform-based opt-outs, the privacy application 115 fills out and submits the applicable webform using any user data required by the webform (e.g., name, address, email, etc.).

At stage 250, the privacy application 115 receives responses to the opt-out requests sent at stage 240 (optionally via the privacy server 120/opt-out engine 122). The responses may be received immediately on submission of the opt-out request (which may occur in the case of a webform request) or at some later time (e.g., after a service provider has manually processed the opt-out request email or webform). The responses may indicate that the opt-out was successful (e.g., the service provider deleted and/or will not share/sell the user's personal information), that additional information or steps are necessary, that the user's data was not found (and therefore cannot be deleted), etc. If the opt-out response is not received immediately, the response will likely be received as an email at some later time.

At stage 260, based on the responses from the service providers received at stage 250, the privacy application 115 determines whether the respective opt-out requests were successful or if more information/steps are needed. The privacy application 115 (optionally in communication with the opt-out engine 122) may use machine learning techniques to make this determination.

In greater detail, the types of opt-out procedures (e.g., email-based, webform-based) and the language of opt-out responses (e.g., successful, more steps needed, user data not found, etc.) can vary dramatically from service provider to service provider. While there are some techniques to automate the task of sending opt-out requests, there is minimal, if any, automation with respect to classifying the different types of opt-out responses and performing any additional steps that may be needed. Rather, a user must manually review each opt-out response to determine if the opt-out was successful or if more information or steps are needed. Given that a single user may receive opt-out responses from hundreds, and possibly thousands, of companies, this is a significant burden to the user and a significant gap in the service provided by an opt-out service provider. Applying machine learning to opt-out responses can allow these responses to be properly classified and completed without user interaction, thereby dramatically improving the performance of the privacy application 115 and the corresponding opt-out service.

Machine learning models are generally categorized as either supervised or unsupervised. A supervised model may further be sub-categorized as either a regression or classification model. Supervised learning involves learning a function that maps an input to an output based on example input-output pairs. For example, given a training dataset with two variables of age (input) and height (output), a supervised learning model could be generated to predict the height of a person based on their age. In regression models, the output is continuous. One example of a regression model is a linear regression, which simply attempts to find a line that best fits the data. Extensions of linear regression include multiple linear regression (e.g., finding a plane of best fit) and polynomial regression (e.g., finding a curve of best fit).

Another example of a machine learning model is a decision tree model. In a decision tree model, a tree structure is defined with a plurality of nodes. Decisions are used to move from a root node at the top of the decision tree to a leaf node at the bottom of the decision tree (i.e., a node with no further child nodes). Generally, a higher number of nodes in the decision tree model is correlated with higher decision accuracy.

Another example of a machine learning model is a decision forest. Random forests are an ensemble learning technique that builds off of decision trees. Random forests involve creating multiple decision trees using bootstrapped datasets of the original data and randomly selecting a subset of variables at each step of the decision tree. The model then selects the mode of all of the predictions of each decision tree. By relying on a “majority wins” model, the risk of error from an individual tree is reduced.

Another example of a machine learning model is a neural network (NN). A neural network is essentially a network of mathematical equations. Neural networks accept one or more input variables, and by going through a network of equations, result in one or more output variables. Put another way, a neural network takes in a vector of inputs and returns a vector of outputs.

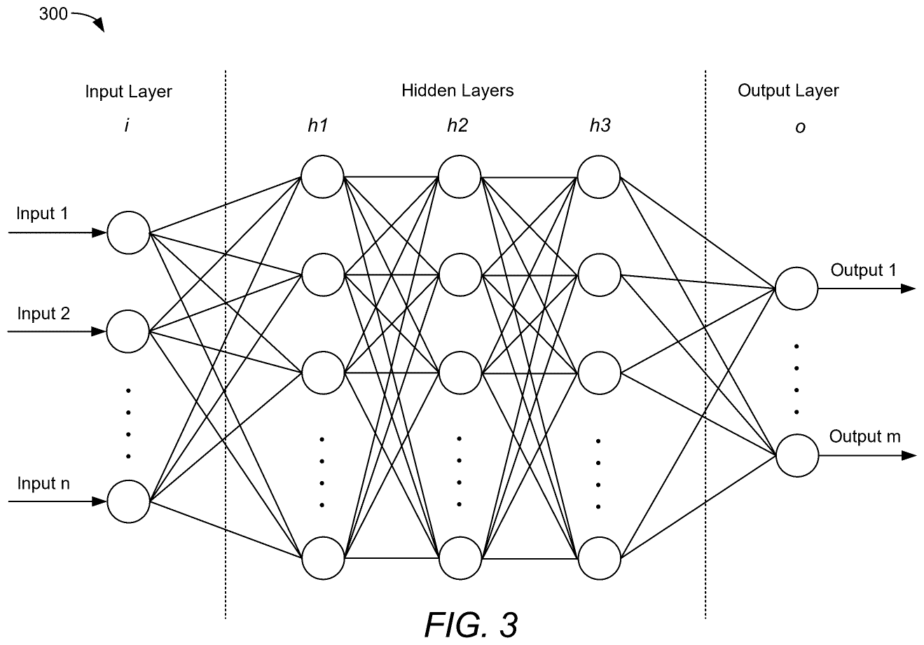

FIG. 3 illustrates an example neural network machine learning model 300, according to aspects of the disclosure. The neural network machine learning model 300 includes an input layer ‘i’ that receives ‘n’ (one or more) inputs (illustrated as “Input 1,” “Input 2,” and “Input n”), one or more hidden layers (illustrated as hidden layers ‘h1,’ ‘h2,’ and ‘h3’) for processing the inputs from the input layer, and an output layer ‘o’ that provides ‘m’ (one or more) outputs (labeled “Output 1” and “Output m”). The number of inputs ‘n,’ hidden layers ‘h,’ and outputs ‘m’ may be the same or different. In some designs, the hidden layers ‘h’ may include linear function(s) and/or activation function(s) that the nodes (illustrated as circles) of each successive hidden layer process from the nodes of the previous hidden layer.

In classification models, the output is discrete. One example of a classification model is logistic regression. Logistic regression is similar to linear regression but is used to model the probability of a finite number of outcomes, typically two. In essence, a logistic equation is created in such a way that the output values can only be between ‘0’ and ‘1.’ Another example of a classification model is a support vector machine. For example, for two classes of data, a support vector machine will find a hyperplane or a boundary between the two classes of data that maximizes the margin between the two classes. There are many planes that can separate the two classes, but only one plane can maximize the margin or distance between the classes. Another example of a classification model is Naïve Bayes, which is based on Bayes Theorem. Other examples of classification models include decision tree, random forest, and neural network, similar to the examples described above except that the output is discrete rather than continuous.

Unlike supervised learning, unsupervised learning is used to draw inferences and find patterns from input data without references to labeled outcomes. Two examples of unsupervised learning models include clustering and dimensionality reduction.

Clustering is an unsupervised technique that involves the grouping, or clustering, of data points. Clustering is frequently used for customer segmentation, fraud detection, and document classification. Common clustering techniques include k-means clustering, hierarchical clustering, mean shift clustering, and density-based clustering. Dimensionality reduction is the process of reducing the number of random variables under consideration by obtaining a set of principal variables. In simpler terms, dimensionality reduction is the process of reducing the dimension of a feature set (in even simpler terms, reducing the number of features). Most dimensionality reduction techniques can be categorized as either feature elimination or feature extraction. One example of dimensionality reduction is called principal component analysis (PCA). In the simplest sense, PCA involves project higher dimensional data (e.g., three dimensions) to a smaller space (e.g., two dimensions). This results in a lower dimension of data (e.g., two dimensions instead of three dimensions) while keeping all original variables in the model.

In some cases, one or more machine learning models may be specifically trained to classify opt-out responses, determine what further steps need to be performed, and generate executable programming code to perform those additional steps. For example, such a machine learning model may be trained on a large number (e.g., thousands) of full-text natural language opt-out responses that have been manually classified/labelled as particular types of opt-out responses (e.g., opt-out successful, user data successfully deleted, more user information needed, more steps needed, user data not found, etc.). That is, a training set of classified opt-out responses may be used as the input (i.e., features) to the machine learning model and the known classification types of the opt-out responses are used as the reference outputs (i.e., labels), thereby enabling later determination (e.g., at stage 260 of FIG. 2) of the same type of output when presented with similar input data (e.g., opt-out responses received at stage 250).

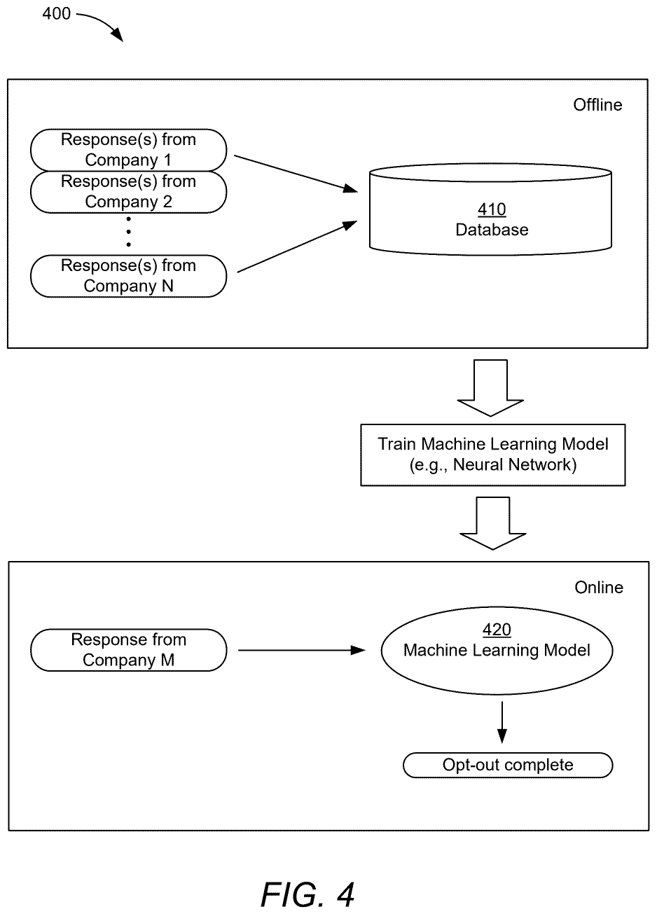

FIG. 4 is a diagram 400 illustrating the use of a machine learning model to classify opt-out responses, according to aspects of the disclosure. In the example of FIG. 4, during an “offline” stage, full-text natural language opt-out responses are stored in a database 410. More specifically, the database 410 may store thousands of full-text natural language opt-out responses from tens to thousands of companies and organizations (illustrated as Companies 1 to N in FIG. 4) that have been manually classified/labelled as particular types of opt-out responses (e.g., opt-out successful, user data successfully deleted, more user information needed, more steps needed, user data not found, etc.). The database 410 may be located, for example, at the privacy server 120 or a third-party server (e.g., a server for the vendor of the machine learning model 420).

Based on the information captured during the offline stage, a machine learning model 420 (e.g., neural network machine learning model 300 of FIG. 3) is trained to classify unclassified opt-out responses (e.g., as received at stage 250 of FIG. 2) to determine the types of opt-out responses (e.g., as at stage 260 of FIG. 2). More specifically, a training set of classified opt-out responses is used as the input (i.e., features) to the machine learning model 420 and the known classification types of the opt-out responses are used as the reference outputs (i.e., labels). The machine learning model 420 may be, for example, a natural language processing (NLP) machine learning model that uses language rules and natural language and contextual artificial intelligence algorithms to classify natural language text.

More specifically, human language is filled with ambiguities that make it very difficult for a computer to accurately determine the intended meaning of text or spoken words. For example, homonyms, homophones, sarcasm, idioms, metaphors, grammar and usage exceptions, and variations in sentence structure are irregularities of human language that programmers must teach natural language-driven applications to recognize and understand accurately for those applications to be useful. To this end, there are different tasks that help the computer “understand” what it's ingesting, such as part of speech tagging/grammatical tagging (determining the part of speech of a particular word or piece of text based on its use and context), word sense disambiguation (selecting the meaning of a word having multiple meanings based on semantic analysis to determine the meaning that makes the most sense in context), named entity recognition (identifying words or phrases as useful entities, such as locations or human names), co-reference resolution (identifying if and when two words refer to the same entity), sentiment analysis (extracting subjective qualities, such as attitudes, emotions, sarcasm, confusion, suspicion, etc., from text), and so on.

After training, the machine learning model 420 can be used to classify any opt-out response (whether email-based or webform-based). More specifically, during an “online” stage (e.g., stage 260 of FIG. 2), the trained machine learning model 420 can be used to classify (infer) the type of opt-out response received from a company “M,” as at, for example, stage 250 of FIG. 2. The machine learning model 420 may classify an opt-out response according to a probability that the opt-out response is a particular type of response (e.g., opt-out successful/complete, user data successfully deleted, user data will not be shared, more user information needed, more steps needed, user data not found, etc.).

The machine learning model 420 may be trained at the privacy server 120 (e.g., the opt-out engine 122) or a third-party server (e.g., a server for the vendor of the machine learning model 420). The machine learning model 420 may be implemented by the privacy application 115, the opt-out engine 122, or a third-party server (e.g., a server for the vendor of the machine learning model 420).

Alternatively, instead of using a specifically trained machine learning model as described above with reference to FIGS. 3 and 4, a natural language general artificial intelligence model, sometimes referred to as a “large language model,” could be used. Large language models (LLMs) are generally neural networks designed for natural language processing tasks that acquire their “knowledge” by learning statistical relationships from vast amounts of text during a self-supervised and semi-supervised training process. As part of the training stage, an LLM is fed a series of words and then predicts the subsequent word(s) in the given sequence. The model then modifies its weight assignments based on its subsequent word predictions. This cycle may be repeated/iterated millions or even billions of times, depending on the size of the dataset, until the model achieves optimal performance.

LLMs can be fine-tuned for specific tasks or be guided by one or more prompts. More specifically, the input to an LLM is referred to as a “prompt,” and designing a prompt is essentially how an LLM model is programmed. A prompt, therefore, usually provides instructions and/or examples of how to successfully complete the task. LLMs can be used for a large variety of tasks, such as content or code generation, summarization, conversation, and creative writing.

Thus, instead of the machine learning model being trained on a specific data set of opt-out responses, as described above with respect to FIGS. 3 and 4, the machine learning model may be a general artificial intelligence model, such as an LLM. In this case, at stage 260, the input, or prompt, to the general artificial intelligence model could be a query as to whether a given response to an opt-out request indicates that the opt-out was successful or not. The input, or prompt, may alternatively or additionally be to classify the type of the response. In this case, the input/prompt may indicate the potential classifications, such as opt-out successful, user data successfully deleted, more user information needed, more steps needed, user data not found, etc.

As another example of performing the determination at stage 260, instead of a machine learning model (whether a specifically trained model or a general artificial intelligence model), a specific algorithm could be used to determine whether an opt-out was successful and optionally to classify the type of opt-out response. For example, for classifying opt-out responses, a keyword-based classification algorithm could use n-grams (e.g., 2-gram, 3-gram, 4-gram) of keywords and/or phrases that are known to be positive or negative responses, or certain types of responses, from a company. These n-grams of keywords may be stored in a database and associated with a corresponding type of opt-out response. For example, the 2-gram of the keywords “successfully processed” and the 3-gram of the keywords “completed your request” may indicate that the opt-out was successful. As another example, the 2-gram of the keywords “not found” may indicate that the user's data was not found, while the 2-gram of the keywords “more information” may indicate that more information is needed from the user.

However the type of opt-out is determined, in the case of a successful opt-out (e.g., user data deleted, company will not share user data, unsubscribe successful, etc.), the privacy application 115 may add that company to a list of successful opt-outs that may be displayed to the user on the user interface of the user device 110 (not shown in FIG. 2). In some cases, the determination at stage 260 may determine that the type of opt-out response is that the user's data was not found and therefore cannot be deleted. In that case, the privacy application 115 may mark the opt-out as complete and/or notify the user.

With continued reference to FIG. 2, in the case that more information and/or steps are necessary to complete the opt-out, at stage 270, the privacy application 115 may determine what the information and/or steps are. In some cases, the privacy application 115 may apply a machine learning model (e.g., a specifically trained model or a general artificial intelligence model) to the response to determine the additional information or steps needed. For example, the user's email address may need to be entered into a webform, and/or a “confirm” button may need to be clicked, and/or one or more checkboxes may need to be selected and submitted, and/or the like.

Upon determining what information and/or steps are needed, the privacy application 115 may prompt the machine learning model to generate executable code (e.g., a script) to enable the privacy application 115 to input the necessary information and/or perform the determined actions. The privacy application 115 may then execute that code to input the necessary information and/or perform the additional steps.

In some cases, the privacy application 115 may not have the necessary information or be able to perform the additional steps. In such cases, the privacy application 115 may notify the user that there is additional information and/or additional steps needed to complete the opt-out. The user may then perform those steps or provide that information manually.

After the additional information has been entered and/or the additional actions have been performed, the method 200 returns to stage 260, where the privacy application 115 again determines whether or not the opt-out was successful. If it was not, the loop from stages 260 to 270 can be performed until the opt-out is successful.

Note that a user may have multiple email accounts. As such, the procedure illustrated in FIG. 2 may be repeated for as many different email accounts the user wishes to process.

As will be appreciated, while FIGS. 1 and 2 illustrate one or more privacy servers 120, as will be appreciated, the techniques described herein may be performed entirely by the privacy application 115 locally on the user device 110. For example, the privacy application 115 may display all service providers identified within the user's email at stage 220, rather than comparing those service providers to the database of service providers 124 stored at the privacy server 120 at stage 210. Or the database of service providers 124 may be stored locally on the user device 110 and accessibly by the privacy application 115.

Alternatively, the privacy application 115 may simply be a communication gateway between the user device 110 (specifically the user's email account/application) and the opt-out engine 122, and the opt-out engine 122 may perform the substantive operations illustrated in FIG. 2. For example, at stage 210, the privacy application 115 may scan the user device 110 for any locally stored emails and send a list of identified service provider domains to the opt-out engine 122. The opt-out engine 122 may scan the user's emails stored on one or more remote email servers and compile a list of identified service providers based on the list received from the privacy application 115 (if any) and its own scan. At stage 220, the opt-out engine 122 may provide the list of identified service providers to the privacy application 115, which may then display the list on the user interface of the user device 110.

Similarly, at stage 230, the privacy application 115 may provide the user selections to the opt-out engine 122, which may then send the opt-out requests to the service providers at stage 240 and receive the responses at stage 250. The opt-out engine 122 may further perform stages 260 and 270.

As yet another alternative, the privacy application 115 may not be necessary at all, and the user may access the opt-out engine 122 via an Internet browser rather than the privacy application 115. In this case, the opt-out engine 122 would perform the operations illustrated in FIG. 2 and interact with the user of the user device 110 as needed (e.g., at stages 220 and 230) via the Internet browser (e.g., an online webform).

In some cases, stages 210 to 230 may not be necessary. Instead, a user may manually transmit an opt-out request to a service provider at stage 240. The opt-out request may be transmitted via the user's email account (e.g., via an unsubscribe link in a spam email), via a webform (e.g., entering the user's email address and clicking “submit”), via a specific interface within the privacy application 115, or via any other opt-out procedure. In this case, the opt-out request may still be generated and transmitted within the privacy application 115 or by an application to which the privacy application 115 has access. For example, the privacy application 115 may be linked to, or otherwise have access to, the user's email account, or the fillable webform may be displayed within the privacy application 115, or the like.

Upon detecting that an opt-out request has been transmitted, the privacy application monitors for the opt-out response, as at stage 250. Once received, the privacy application 115 may determine whether the opt-out was successful or whether additional information and/or actions are needed, as at stage 260. In some cases, as described above, the privacy application 115 may apply a machine learning model (e.g., a specifically trained model or a general artificial intelligence model) to the opt-out response to make the determination. The privacy application 115 may then proceed to stage 270 as needed. Again, the privacy application 115 may apply a machine learning model (e.g., a specifically trained model or a general artificial intelligence model) to the opt-out response to generate the executable code to enter the additional information and/or perform the additional actions.

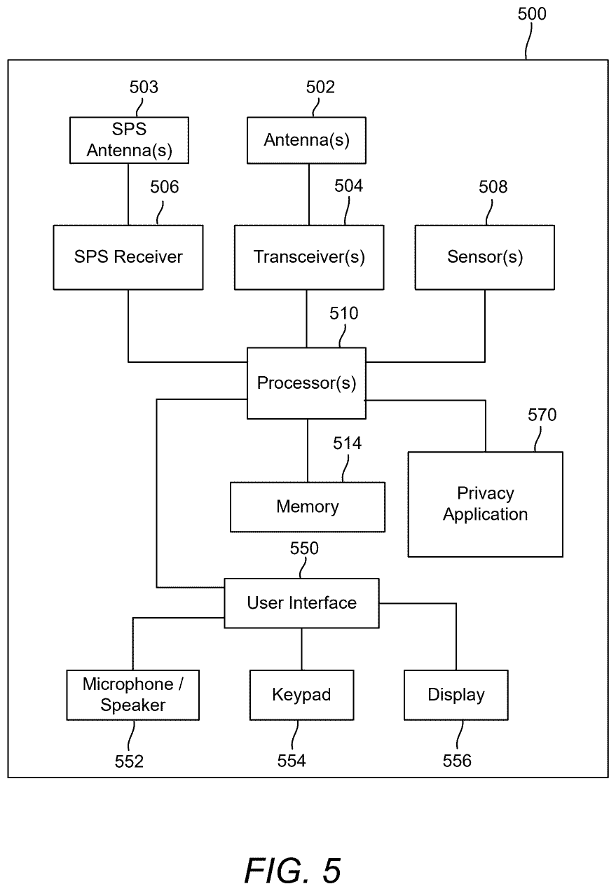

FIG. 5 is a block diagram illustrating various components of an example user device 500, according to aspects of the disclosure. In an aspect, the user device may correspond to any of the user devices described herein, such as user device 110 in FIG. 1. As a specific example, the user device 500 may be a smartphone, a tablet computer, a laptop computer, a desktop computer, or the like.

For the sake of simplicity, the various features and functions illustrated in the block diagram of FIG. 5 are connected together using a common data bus that is meant to represent that these various features and functions are operatively coupled together. Those skilled in the art will recognize that other connections, mechanisms, features, functions, or the like, may be provided and adapted as necessary to operatively couple and configure an actual user device. Further, it is also recognized that one or more of the features or functions illustrated in the example of FIG. 5 may be further subdivided, or two or more of the features or functions illustrated in FIG. 5 may be combined.

The user device 500 may include one or more transceivers 504 connected to one or more antennas 502 and providing means for communicating (e.g., means for transmitting, means for receiving, means for measuring, means for tuning, means for refraining from transmitting, etc.) with other network nodes, such as other user devices 110 and/or the privacy server(s) 120 via at least one designated radio access technology (RAT) (e.g., Wi-Fi, Long-Term Evolution (LTE), Fifth Generation New Radio (5G NR), etc.) over one or more wireless communication links. The one or more transceivers 504 may be variously configured for transmitting and encoding wireless signals (e.g., messages, indications, information, and so on), and, conversely, for receiving and decoding wireless signals (e.g., messages, indications, information, pilots, and so on) in accordance with the designated RAT. In an aspect, the one or more transceivers 504 and the antenna(s) 502 may form a (wireless) communication interface of the user device 500.

As used herein, a “transceiver” may include at least one transmitter and at least one receiver in an integrated device (e.g., embodied as a transmitter circuit and a receiver circuit of a single communication device) in some implementations, may comprise a separate transmitter device and a separate receiver device in some implementations, or may be embodied in other ways in other implementations. In an aspect, a transmitter may include or be coupled to a plurality of antennas (e.g., antenna(s) 502), such as an antenna array. Similarly, a receiver may include or be coupled to a plurality of antennas (e.g., antenna(s) 502), such as an antenna array. In an aspect, the transmitter(s) and receiver(s) may share the same plurality of antennas (e.g., antenna(s) 502), such that the user device 500 can only receive or transmit at a given time, not both at the same time. In some cases, a transceiver may not provide both transmit and receive functionalities. For example, a low functionality receiver circuit may be employed in some designs to reduce costs when providing full communication is not necessary (e.g., a receiver chip or similar circuitry simply providing low-level sniffing).

The user device 500 may also include a satellite positioning system (SPS) receiver 506. The SPS receiver 506 may be connected to the one or more SPS antennas 503 and may provide means for receiving and/or measuring satellite signals. The SPS receiver 506 may comprise any suitable hardware and/or software for receiving and processing SPS signals, such as global positioning system (GPS) signals. The SPS receiver 506 requests information and operations as appropriate from the other systems, and performs the calculations necessary to determine the user device's 500 position using measurements obtained by any suitable SPS algorithm.

One or more sensors 508 may be coupled to one or more processors 510 and may provide means for sensing or detecting information related to the state and/or environment of the user device 500, such as speed, heading (e.g., compass heading), headlight status, gas mileage, etc. By way of example, the one or more sensors 508 may include a speedometer, a tachometer, an accelerometer (e.g., a microelectromechanical systems (MEMS) device), a gyroscope, a geomagnetic sensor (e.g., a compass), an altimeter (e.g., a barometric pressure altimeter), etc.

The one or more processors 510 may include one or more central processing units (CPUs), microprocessors, microcontrollers, ASICs, processing cores, digital signal processors (DSPs), field-programmable gate arrays (FPGAs), or the like that provide processing functions, as well as other calculation and control functionality. The one or more processors 510 may therefore provide means for processing, such as means for determining, means for calculating, means for receiving, means for transmitting, means for indicating, etc. The one or more processors 510 may include any form of logic suitable for performing, or causing the components of the user device 500 to perform, at least the techniques described herein.

The one or more processors 510 may also be coupled to a memory 514 providing means for storing (including means for retrieving, means for maintaining, etc.) data and software instructions for executing programmed functionality within the user device 500. The memory 514 may be on-board the one or more processors 510 (e.g., within the same integrated circuit (IC) package), and/or the memory 514 may be external to the one or more processors 510 and functionally coupled over a data bus.

The user device 500 may include a user interface 550 that provides any suitable interface systems, such as a microphone/speaker 552, keypad 554, and display 556 that allow user interaction with the user device 500. The microphone/speaker 552 may provide for voice communication services with the user device 500. The keypad 554 may comprise any suitable buttons for user input to the user device 500. The display 556 may comprise any suitable display, such as, for example, a backlit liquid crystal display (LCD), and may further include a touch screen display for additional user input modes. The user interface 550 may therefore be a means for providing indications (e.g., audible and/or visual indications) to a user and/or for receiving user input (e.g., via user actuation of a sensing device such a keypad, a touch screen, a microphone, and so on).

In an aspect, the user device 500 may include a privacy application 570 (which may correspond to privacy application 115) coupled to the one or more processors 510. The privacy application 570 may be a hardware, software, or firmware component that, when executed, causes the user device 500 to perform the operations described herein. For example, the privacy application 570 may be a software module stored in memory 514 and executable by the one or more processors 510. As another example, the privacy application 570 may be a hardware circuit (e.g., an ASIC, an FPGA, etc.) within the user device 500.

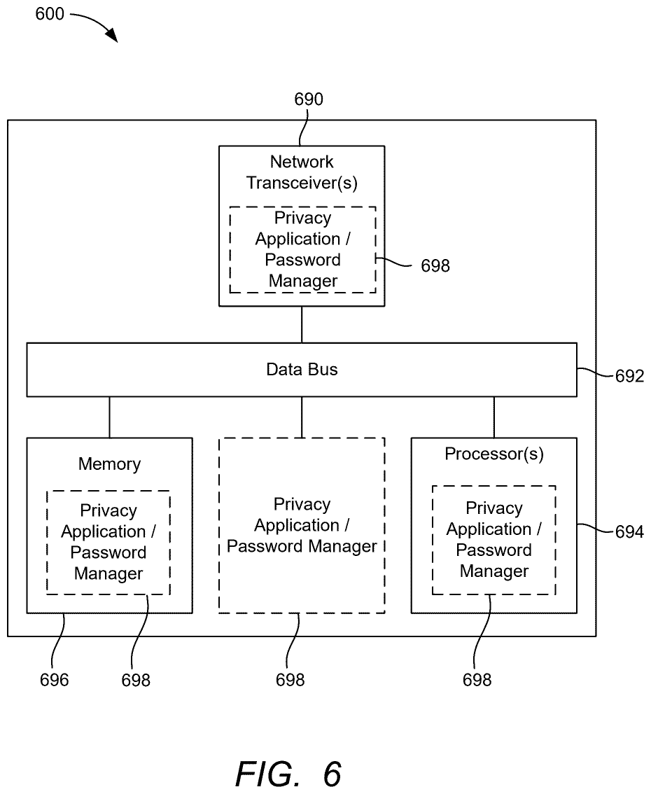

FIG. 6 illustrates several example components (represented by corresponding blocks) that may be incorporated into a privacy server 600 (which may correspond to a privacy server 120) to support the operations described herein.

The privacy server 600 may include one or more network transceivers 690 providing means for communicating (e.g., means for transmitting, means for receiving, etc.) with other network entities (e.g., other privacy servers 600/120). For example, the privacy server 600 may employ the one or more network transceivers 690 to communicate with other privacy servers 600/120 over one or more wired or wireless network interfaces.

The privacy server 600 may also include other components that may be used in conjunction with the operations as disclosed herein. The privacy server 600 may include one or more processors 694 for providing functionality relating to, for example, password manager procedures, as described herein, and for providing other processing functionality. The one or more processors 694 may therefore provide means for processing, such as means for determining, means for calculating, means for receiving, means for transmitting, means for indicating, etc. In an aspect, the one or more processors 694 may include, for example, one or more general purpose processors, multi-core processors, CPUs, ASICs, DSPs, FPGAs, other programmable logic devices or processing circuitry, or various combinations thereof.

The privacy server 600 may include memory circuitry implementing one or more memories 696 (e.g., each including a memory device) for maintaining information (e.g., the database of service providers 124). The one or more memories 696 may therefore provide means for storing, means for retrieving, means for maintaining, etc. In some cases, the privacy server 600 may include a privacy application 698 (which may correspond to the privacy application 115). The privacy application 698 may be hardware circuits that are part of or coupled to the one or more processors 694 that, when executed, cause the privacy server 600 to perform the functionality described herein. In other aspects, the privacy application 698 may be external to the one or more processors 694 (e.g., part of a modem processing system, integrated with another processing system, etc.). Alternatively, the privacy application 698 may be a memory module stored in the one or more memories 696 that, when executed by the one or more processors 694 (or a modem processing system, another processing system, etc.), cause the privacy server 600 to perform the functionality described herein. FIG. 6 illustrates possible locations of the privacy application 698, which may be, for example, part of the one or more network transceivers 690, the one or more memories 696, the one or more processors 694, or any combination thereof, or may be a standalone component.

The various components of the privacy server 600 may be communicatively coupled to each other over a data bus 692. In an aspect, the data bus 692 may form, or be part of, a communication interface of the privacy server 600. For example, where different logical entities are embodied in the same device, the data bus 692 may provide communication between them.

The components of FIG. 6 may be implemented in various ways. In some cases, the components of FIG. 6 may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 690 to 698 may be implemented by processor and memory component(s) of the privacy server 600 (e.g., by execution of appropriate code and/or by appropriate configuration of processor components). For simplicity, various operations, acts, and/or functions are described herein as being performed “by a privacy server.” However, as will be appreciated, such operations, acts, and/or functions may actually be performed by specific components or combinations of components of the privacy server 600, such as the one or more processors 694, the one or more network transceivers 690, the one or more memories 696, the privacy application 698, etc.

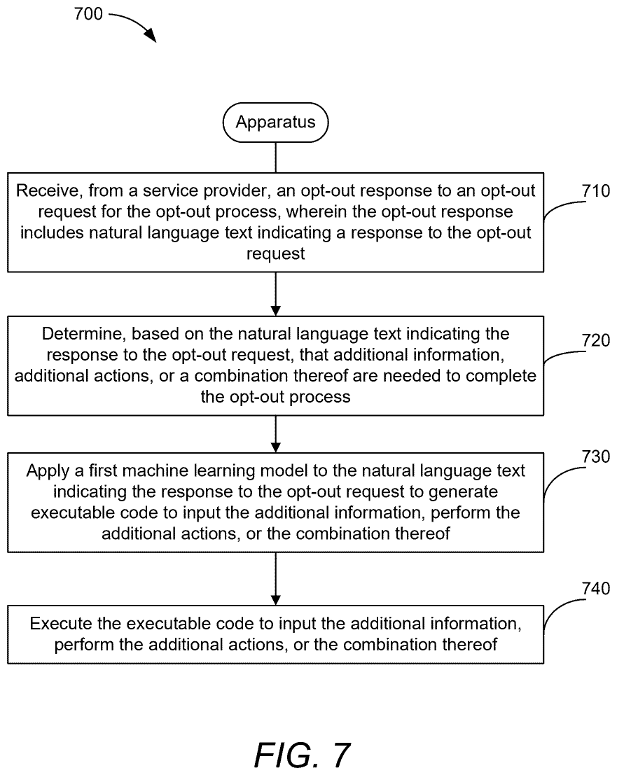

FIG. 7 illustrates an example method 700 for completing an opt-out process, according to aspects of the disclosure. In an aspect, method 700 may be performed by an apparatus (e.g., user device 500 or privacy server 600). In some cases, the apparatus may be a component of the user device 500 or the privacy server 600, such as a processing system (e.g., the one or more processors 510 of the user device 500 or the one or more processors 694 of the privacy server 600, optionally in combination with other components of the user device 500 or the privacy server 600).

At operation 710, the apparatus receives, from a service provider, an opt-out response to an opt-out request for the opt-out process, where the opt-out response includes natural language text indicating a response to the opt-out request, as at stage 250 of FIG. 2.

In an aspect, where the apparatus is, or is a component of, a user device 500, operation 710 may be performed by the one or more transceivers 504, the one or more processors 510, memory 514, the user interface 550, and/or privacy application 570, any or all of which may be considered means for performing this operation.

In an aspect, where the apparatus is, or is a component of, a privacy server 600, operation 710 may be performed the one or more network transceivers 690, the one or more processors 694, memory 696, and/or privacy application 698, any or all of which may be considered means for performing this operation.

At operation 720, the apparatus determines, based on the natural language text indicating the response to the opt-out request, that additional information, additional actions, or a combination thereof are needed to complete the opt-out process, as at stage 260 of FIG. 2.

In an aspect, where the apparatus is, or is a component of, a user device 500, operation 720 may be performed by the one or more transceivers 504, the one or more processors 510, memory 514, the user interface 550, and/or privacy application 570, any or all of which may be considered means for performing this operation.

In an aspect, where the apparatus is, or is a component of, a privacy server 600, operation 720 may be performed the one or more network transceivers 690, the one or more processors 694, memory 696, and/or privacy application 698, any or all of which may be considered means for performing this operation.

At operation 730, the apparatus applies a first machine learning model to the natural language text indicating the response to the opt-out request to generate executable code to input the additional information, perform the additional actions, or the combination thereof, as at stage 270 of FIG. 2.

In an aspect, where the apparatus is, or is a component of, a user device 500, operation 730 may be performed by the one or more transceivers 504, the one or more processors 510, memory 514, the user interface 550, and/or privacy application 570, any or all of which may be considered means for performing this operation.

In an aspect, where the apparatus is, or is a component of, a privacy server 600, operation 730 may be performed the one or more network transceivers 690, the one or more processors 694, memory 696, and/or privacy application 698, any or all of which may be considered means for performing this operation.

At operation 740, the apparatus executes the executable code to input the additional information, perform the additional actions, or the combination thereof, as at stage 270 of FIG. 2.

In an aspect, where the apparatus is, or is a component of, a user device 500, operation 740 may be performed by the one or more transceivers 504, the one or more processors 510, memory 514, the user interface 550, and/or privacy application 570, any or all of which may be considered means for performing this operation.

In an aspect, where the apparatus is, or is a component of, a privacy server 600, operation 740 may be performed the one or more network transceivers 690, the one or more processors 694, memory 696, and/or privacy application 698, any or all of which may be considered means for performing this operation.

In some cases, determining that the additional information, the additional actions, or the combination thereof are needed to complete the opt-out process at stage 720 includes applying the first machine learning model to the natural language text indicating the response to the opt-out request to determine that the additional information, the additional actions, or the combination thereof are needed to complete the opt-out process.

In some cases, determining that the additional information, the additional actions, or the combination thereof are needed to complete the opt-out process at stage 720 includes applying a second machine learning model to the natural language text indicating the response to the opt-out request to determine that the additional information, the additional actions, or the combination thereof are needed to complete the opt-out process.

In some cases, the first machine learning model is a general artificial intelligence model (e.g., an LLM model). In some cases, the first machine learning model is iteratively trained on a natural language dataset.

In some cases, the opt-out response may be an email containing the natural language text indicating the response to the opt-out request, or a webform containing the natural language text indicating the response to the opt-out request.

In some cases, the opt-out response indicates that the additional information is needed to complete the opt-out process, the opt-out response includes an email address or a hyperlink to a webform for providing the additional information, and executing the executable code at stage 740 includes populating the webform with the additional information; or transmitting an email including the additional information to the email address.

In some cases, the opt-out response includes a list of the additional actions needed to complete the opt-out process, and executing the executable code at stage 740 includes performing the list of the additional actions needed to complete the opt-out process.

In some cases, the method 700 may further include (not shown) receiving a second opt-out response in response to execution of the executable code, where the second opt-out response includes second natural language text indicating a response to the execution of the executable code; and determining, based on the second natural language text indicating the response to the execution of the executable code, whether the opt-out process is complete.

In some cases, the method 700 may further include (not shown) determining, based on the second natural language text indicating the response to the execution of the executable code, that second additional information, second additional actions, or a combination thereof are needed to complete the opt-out process; applying the first machine learning model to the second natural language text indicating the response to the execution of the executable code to generate second executable code to input the second additional information, perform the second additional actions, or the combination thereof; and executing the second executable code to input the second additional information, perform the second additional actions, or the combination thereof.

In some cases, the method 700 may further include (not shown) receiving the first machine learning model from a server.

In some cases, applying the first machine learning model at stage 730 includes transmitting the opt-out response to a server implementing the first machine learning model; and receiving the executable code from the server.

In some cases, the method 700 may further include (not shown) transmitting the opt-out request to the service provider, where the opt-out request comprises an email composed by the apparatus or a webform populated by the apparatus requesting that the service provider delete personal information of a user stored by the service provider, refrain from sharing the personal information of the user with other entities, refrain from selling the personal information of the user with other entities, provide a copy of the personal information of the user that the service provider holds, or any combination thereof, as at stage 240 of FIG. 2.

In some cases, the method 700 may further include (not shown) scanning an email account of a user to identify a set of service providers from which the email account of the user has received one or more emails, where the service provider is one of the set of service providers, as at stage 210 of FIG. 2.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an electrical insulator and an electrical conductor). Furthermore, it is also intended that aspects of a clause can be included in any other independent clause, even if the clause is not directly dependent on the independent clause.

Implementation examples are described in the following numbered clauses:

Clause 1. A method for completing an opt-out process performed by an apparatus, comprising: receiving, from a service provider, an opt-out response to an opt-out request for the opt-out process, wherein the opt-out response includes natural language text indicating a response to the opt-out request; determining, based on the natural language text indicating the response to the opt-out request, that additional information, additional actions, or a combination thereof are needed to complete the opt-out process; applying a first machine learning model to the natural language text indicating the response to the opt-out request to generate executable code to input the additional information, perform the additional actions, or the combination thereof; and executing the executable code to input the additional information, perform the additional actions, or the combination thereof.

Clause 2. The method of clause 1, wherein determining that the additional information, the additional actions, or the combination thereof are needed to complete the opt-out process comprises: applying the first machine learning model to the natural language text indicating the response to the opt-out request to determine that the additional information, the additional actions, or the combination thereof are needed to complete the opt-out process.

Clause 3. The method of any of clauses 1 to 2, wherein determining that the additional information, the additional actions, or the combination thereof are needed to complete the opt-out process comprises: applying a second machine learning model to the natural language text indicating the response to the opt-out request to determine that the additional information, the additional actions, or the combination thereof are needed to complete the opt-out process.

Clause 4. The method of any of clauses 1 to 3, wherein the first machine learning model is a general artificial intelligence model.

Clause 5. The method of any of clauses 1 to 4, wherein the first machine learning model is iteratively trained on a natural language dataset.

Clause 6. The method of any of clauses 1 to 5, wherein the opt-out response is: an email containing the natural language text indicating the response to the opt-out request, or a webform containing the natural language text indicating the response to the opt-out request.

Clause 7. The method of any of clauses 1 to 6, wherein: the opt-out response indicates that the additional information is needed to complete the opt-out process, the opt-out response includes an email address or a hyperlink to a webform for providing the additional information, and executing the executable code comprises: populating the webform with the additional information; or transmitting an email including the additional information to the email address.

Clause 8. The method of any of clauses 1 to 7, wherein: the opt-out response includes a list of the additional actions needed to complete the opt-out process, and executing the executable code comprises performing the list of the additional actions needed to complete the opt-out process.

Clause 9. The method of any of clauses 1 to 8, further comprising: receiving a second opt-out response in response to execution of the executable code, wherein the second opt-out response includes second natural language text indicating a response to the execution of the executable code; and determining, based on the second natural language text indicating the response to the execution of the executable code, whether the opt-out process is complete.

Clause 10. The method of clause 9, further comprising: determining, based on the second natural language text indicating the response to the execution of the executable code, that second additional information, second additional actions, or a combination thereof are needed to complete the opt-out process; applying the first machine learning model to the second natural language text indicating the response to the execution of the executable code to generate second executable code to input the second additional information, perform the second additional actions, or the combination thereof; and executing the second executable code to input the second additional information, perform the second additional actions, or the combination thereof.

Clause 11. The method of any of clauses 1 to 10, further comprising: receiving the first machine learning model from a server.

Clause 12. The method of any of clauses 1 to 11, wherein applying the first machine learning model comprises: transmitting the opt-out response to a server implementing the first machine learning model; and receiving the executable code from the server.

Clause 13. The method of any of clauses 1 to 12, further comprising: transmitting the opt-out request to the service provider, wherein the opt-out request comprises an email composed by the apparatus or a webform populated by the apparatus requesting that the service provider delete personal information of a user stored by the service provider, refrain from sharing the personal information of the user with other entities, refrain from selling the personal information of the user with other entities, provide a copy of the personal information of the user that the service provider holds, or any combination thereof.

Clause 14. The method of any of clauses 1 to 13, further comprising: scanning an email account of a user to identify a set of service providers from which the email account of the user has received one or more emails, wherein the service provider is one of the set of service providers.

Clause 15. The method of any of clauses 1 to 14, wherein the apparatus is: a user device of a user, or a server.

Clause 16. An apparatus, comprising: one or more memories; one or more transceivers; and one or more processors communicatively coupled to the one or more memories and the one or more transceivers, the one or more processors, either alone or in combination, configured to: receive, via the one or more transceivers, from a service provider, an opt-out response to an opt-out request for the opt-out process, wherein the opt-out response includes natural language text indicating a response to the opt-out request; determine, based on the natural language text indicating the response to the opt-out request, that additional information, additional actions, or a combination thereof are needed to complete the opt-out process; apply a first machine learning model to the natural language text indicating the response to the opt-out request to generate executable code to input the additional information, perform the additional actions, or the combination thereof; and execute the executable code to input the additional information, perform the additional actions, or the combination thereof.

Clause 17. The apparatus of clause 16, wherein the one or more processors configured to determine that the additional information, the additional actions, or the combination thereof are needed to complete the opt-out process comprise the one or more processors, either alone or in combination, configured to: apply the first machine learning model to the natural language text indicating the response to the opt-out request to determine that the additional information, the additional actions, or the combination thereof are needed to complete the opt-out process.

Clause 18. The apparatus of any of clauses 16 to 17, wherein the one or more processors configured to determine that the additional information, the additional actions, or the combination thereof are needed to complete the opt-out process comprise the one or more processors, either alone or in combination, configured to: apply a second machine learning model to the natural language text indicating the response to the opt-out request to determine that the additional information, the additional actions, or the combination thereof are needed to complete the opt-out process.

Clause 19. The apparatus of any of clauses 16 to 18, wherein the first machine learning model is a general artificial intelligence model.

Clause 20. The apparatus of any of clauses 16 to 19, wherein the first machine learning model is iteratively trained on a natural language dataset.

Clause 21. The apparatus of any of clauses 16 to 20, wherein the opt-out response is: an email containing the natural language text indicating the response to the opt-out request, or a webform containing the natural language text indicating the response to the opt-out request.

Clause 22. The apparatus of any of clauses 16 to 21, wherein: the opt-out response indicates that the additional information is needed to complete the opt-out process, the opt-out response includes an email address or a hyperlink to a webform for providing the additional information, and the one or more processors configured to execute the executable code comprises the one or more processors, either alone or in combination, configured to: populate the webform with the additional information; or transmit, via the one or more transceivers, an email including the additional information to the email address.

Clause 23. The apparatus of any of clauses 16 to 22, wherein: the opt-out response includes a list of the additional actions needed to complete the opt-out process, and the one or more processors configured to execute the executable code comprises the one or more processors, either alone or in combination, configured to perform the list of the additional actions needed to complete the opt-out process.

Clause 24. The apparatus of any of clauses 16 to 23, wherein the one or more processors, either alone or in combination, are further configured to: receive, via the one or more transceivers, a second opt-out response in response to execution of the executable code, wherein the second opt-out response includes second natural language text indicating a response to the execution of the executable code; and determine, based on the second natural language text indicating the response to the execution of the executable code, whether the opt-out process is complete.

Clause 25. The apparatus of clause 24, wherein the one or more processors, either alone or in combination, are further configured to: determine, based on the second natural language text indicating the response to the execution of the executable code, that second additional information, second additional actions, or a combination thereof are needed to complete the opt-out process; apply the first machine learning model to the second natural language text indicating the response to the execution of the executable code to generate second executable code to input the second additional information, perform the second additional actions, or the combination thereof; and execute the second executable code to input the second additional information, perform the second additional actions, or the combination thereof.

Clause 26. The apparatus of any of clauses 16 to 25, wherein the one or more processors, either alone or in combination, are further configured to: receive, via the one or more transceivers, the first machine learning model from a server.

Clause 27. The apparatus of any of clauses 16 to 26, wherein the one or more processors configured to apply the first machine learning model comprise the one or more processors, either alone or in combination, configured to: transmit, via the one or more transceivers, the opt-out response to a server implementing the first machine learning model; and receive, via the one or more transceivers, the executable code from the server.

Clause 28. The apparatus of any of clauses 16 to 27, wherein the one or more processors, either alone or in combination, are further configured to: transmit, via the one or more transceivers, the opt-out request to the service provider, wherein the opt-out request comprises an email composed by the apparatus or a webform populated by the apparatus requesting that the service provider delete personal information of a user stored by the service provider, refrain from sharing the personal information of the user with other entities, refrain from selling the personal information of the user with other entities, provide a copy of the personal information of the user that the service provider holds, or any combination thereof.

Clause 29. The apparatus of any of clauses 16 to 28, wherein the one or more processors, either alone or in combination, are further configured to: scan an email account of a user to identify a set of service providers from which the email account of the user has received one or more emails, wherein the service provider is one of the set of service providers.

Clause 30. The apparatus of any of clauses 16 to 29, wherein the apparatus is: a user device of a user, or a server.

Clause 31. An apparatus, comprising: means for receiving, from a service provider, an opt-out response to an opt-out request for the opt-out process, wherein the opt-out response includes natural language text indicating a response to the opt-out request; means for determining, based on the natural language text indicating the response to the opt-out request, that additional information, additional actions, or a combination thereof are needed to complete the opt-out process; means for applying a first machine learning model to the natural language text indicating the response to the opt-out request to generate executable code to input the additional information, perform the additional actions, or the combination thereof; and means for executing the executable code to input the additional information, perform the additional actions, or the combination thereof.

Clause 32. The apparatus of clause 31, wherein the means for determining that the additional information, the additional actions, or the combination thereof are needed to complete the opt-out process comprises: means for applying the first machine learning model to the natural language text indicating the response to the opt-out request to determine that the additional information, the additional actions, or the combination thereof are needed to complete the opt-out process.

Clause 33. The apparatus of any of clauses 31 to 32, wherein the means for determining that the additional information, the additional actions, or the combination thereof are needed to complete the opt-out process comprises: means for applying a second machine learning model to the natural language text indicating the response to the opt-out request to determine that the additional information, the additional actions, or the combination thereof are needed to complete the opt-out process.

Clause 34. The apparatus of any of clauses 31 to 33, wherein the first machine learning model is a general artificial intelligence model.

Clause 35. The apparatus of any of clauses 31 to 34, wherein the first machine learning model is iteratively trained on a natural language dataset.

Clause 36. The apparatus of any of clauses 31 to 35, wherein the opt-out response is: an email containing the natural language text indicating the response to the opt-out request, or a webform containing the natural language text indicating the response to the opt-out request.

Clause 37. The apparatus of any of clauses 31 to 36, wherein: the opt-out response indicates that the additional information is needed to complete the opt-out process, the opt-out response includes an email address or a hyperlink to a webform for providing the additional information, and the means for executing the executable code comprises: means for populating the webform with the additional information; or means for transmitting an email including the additional information to the email address.

Clause 38. The apparatus of any of clauses 31 to 37, wherein: the opt-out response includes a list of the additional actions needed to complete the opt-out process, and the means for executing the executable code comprises means for performing the list of the additional actions needed to complete the opt-out process.

Clause 39. The apparatus of any of clauses 31 to 38, further comprising: means for receiving a second opt-out response in response to execution of the executable code, wherein the second opt-out response includes second natural language text indicating a response to the execution of the executable code; and means for determining, based on the second natural language text indicating the response to the execution of the executable code, whether the opt-out process is complete.

Clause 40. The apparatus of clause 39, further comprising: means for determining, based on the second natural language text indicating the response to the execution of the executable code, that second additional information, second additional actions, or a combination thereof are needed to complete the opt-out process; means for applying the first machine learning model to the second natural language text indicating the response to the execution of the executable code to generate second executable code to input the second additional information, perform the second additional actions, or the combination thereof; and means for executing the second executable code to input the second additional information, perform the second additional actions, or the combination thereof.

Clause 41. The apparatus of any of clauses 31 to 40, further comprising: means for receiving the first machine learning model from a server.

Clause 42. The apparatus of any of clauses 31 to 41, wherein the means for applying the first machine learning model comprises: means for transmitting the opt-out response to a server implementing the first machine learning model; and means for receiving the executable code from the server.

Clause 43. The apparatus of any of clauses 31 to 42, further comprising: means for transmitting the opt-out request to the service provider, wherein the opt-out request comprises an email composed by the apparatus or a webform populated by the apparatus requesting that the service provider delete personal information of a user stored by the service provider, refrain from sharing the personal information of the user with other entities, refrain from selling the personal information of the user with other entities, provide a copy of the personal information of the user that the service provider holds, or any combination thereof.

Clause 44. The apparatus of any of clauses 31 to 43, further comprising: means for scanning an email account of a user to identify a set of service providers from which the email account of the user has received one or more emails, wherein the service provider is one of the set of service providers.

Clause 45. The apparatus of any of clauses 31 to 44, wherein the apparatus is: a user device of a user, or a server.

Clause 46. A non-transitory computer-readable medium storing computer-executable instructions that, when executed by an apparatus, cause the apparatus to: receive, from a service provider, an opt-out response to an opt-out request for the opt-out process, wherein the opt-out response includes natural language text indicating a response to the opt-out request; determine, based on the natural language text indicating the response to the opt-out request, that additional information, additional actions, or a combination thereof are needed to complete the opt-out process; apply a first machine learning model to the natural language text indicating the response to the opt-out request to generate executable code to input the additional information, perform the additional actions, or the combination thereof; and execute the executable code to input the additional information, perform the additional actions, or the combination thereof.

Clause 47. The non-transitory computer-readable medium of clause 46, wherein the computer-executable instructions that, when executed by the apparatus, cause the apparatus to determine that the additional information, the additional actions, or the combination thereof are needed to complete the opt-out process comprise computer-executable instructions that, when executed by the apparatus, cause the apparatus to: apply the first machine learning model to the natural language text indicating the response to the opt-out request to determine that the additional information, the additional actions, or the combination thereof are needed to complete the opt-out process.

Clause 48. The non-transitory computer-readable medium of any of clauses 46 to 47, wherein the computer-executable instructions that, when executed by the apparatus, cause the apparatus to determine that the additional information, the additional actions, or the combination thereof are needed to complete the opt-out process comprise computer-executable instructions that, when executed by the apparatus, cause the apparatus to: apply a second machine learning model to the natural language text indicating the response to the opt-out request to determine that the additional information, the additional actions, or the combination thereof are needed to complete the opt-out process.

Clause 49. The non-transitory computer-readable medium of any of clauses 46 to 48, wherein the first machine learning model is a general artificial intelligence model.

Clause 50. The non-transitory computer-readable medium of any of clauses 46 to 49, wherein the first machine learning model is iteratively trained on a natural language dataset.

Clause 51. The non-transitory computer-readable medium of any of clauses 46 to 50, wherein the opt-out response is: an email containing the natural language text indicating the response to the opt-out request, or a webform containing the natural language text indicating the response to the opt-out request.

Clause 52. The non-transitory computer-readable medium of any of clauses 46 to 51, wherein: the opt-out response indicates that the additional information is needed to complete the opt-out process, the opt-out response includes an email address or a hyperlink to a webform for providing the additional information, and the computer-executable instructions that, when executed by the apparatus, cause the apparatus to execute the executable code comprises computer-executable instructions that, when executed by the apparatus, cause the apparatus to: populate the webform with the additional information; or transmit an email including the additional information to the email address.

Clause 53. The non-transitory computer-readable medium of any of clauses 46 to 52, wherein: the opt-out response includes a list of the additional actions needed to complete the opt-out process, and the computer-executable instructions that, when executed by the apparatus, cause the apparatus to execute the executable code comprises computer-executable instructions that, when executed by the apparatus, cause the apparatus to perform the list of the additional actions needed to complete the opt-out process.

Clause 54. The non-transitory computer-readable medium of any of clauses 46 to 53, further comprising computer-executable instructions that, when executed by the apparatus, cause the apparatus to: receive a second opt-out response in response to execution of the executable code, wherein the second opt-out response includes second natural language text indicating a response to the execution of the executable code; and determine, based on the second natural language text indicating the response to the execution of the executable code, whether the opt-out process is complete.

Clause 55. The non-transitory computer-readable medium of clause 54, further comprising computer-executable instructions that, when executed by the apparatus, cause the apparatus to: determine, based on the second natural language text indicating the response to the execution of the executable code, that second additional information, second additional actions, or a combination thereof are needed to complete the opt-out process; apply the first machine learning model to the second natural language text indicating the response to the execution of the executable code to generate second executable code to input the second additional information, perform the second additional actions, or the combination thereof; and execute the second executable code to input the second additional information, perform the second additional actions, or the combination thereof.

Clause 56. The non-transitory computer-readable medium of any of clauses 46 to 55, further comprising computer-executable instructions that, when executed by the apparatus, cause the apparatus to: receive the first machine learning model from a server.

Clause 57. The non-transitory computer-readable medium of any of clauses 46 to 56, wherein the computer-executable instructions that, when executed by the apparatus, cause the apparatus to apply the first machine learning model comprise computer-executable instructions that, when executed by the apparatus, cause the apparatus to: transmit the opt-out response to a server implementing the first machine learning model; and receive the executable code from the server.

Clause 58. The non-transitory computer-readable medium of any of clauses 46 to 57, further comprising computer-executable instructions that, when executed by the apparatus, cause the apparatus to: transmit the opt-out request to the service provider, wherein the opt-out request comprises an email composed by the apparatus or a webform populated by the apparatus requesting that the service provider delete personal information of a user stored by the service provider, refrain from sharing the personal information of the user with other entities, refrain from selling the personal information of the user with other entities, provide a copy of the personal information of the user that the service provider holds, or any combination thereof.

Clause 59. The non-transitory computer-readable medium of any of clauses 46 to 58, further comprising computer-executable instructions that, when executed by the apparatus, cause the apparatus to: scan an email account of a user to identify a set of service providers from which the email account of the user has received one or more emails, wherein the service provider is one of the set of service providers.

Clause 60. The non-transitory computer-readable medium of any of clauses 46 to 59, wherein the apparatus is: a user device of a user, or a server.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a DSP, an ASIC, an FPGA, or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., a user equipment (UE)). In the alternative, the processor and the storage medium may reside as discrete components in a user terminal.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. For example, the functions, steps and/or actions of the method claims in accordance with the aspects of the disclosure described herein need not be performed in any particular order. Further, no component, function, action, or instruction described or claimed herein should be construed as critical or essential unless explicitly described as such. Furthermore, as used herein, the terms “set,” “group,” and the like are intended to include one or more of the stated elements. Also, as used herein, the terms “has,” “have,” “having,” “comprises,” “comprising,” “includes,” “including,” and the like does not preclude the presence of one or more additional elements (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”) or the alternatives are mutually exclusive (e.g., “one or more” should not be interpreted as “one and more”). Furthermore, although components, functions, actions, and instructions may be described or claimed in the singular, the plural is contemplated unless limitation to the singular is explicitly stated. Accordingly, as used herein, the articles “a,” “an,” “the,” and “said” are intended to include one or more of the stated elements. Additionally, as used herein, the terms “at least one” and “one or more” encompass “one” component, function, action, or instruction performing or capable of performing a described or claimed functionality and also “two or more” components, functions, actions, or instructions performing or capable of performing a described or claimed functionality in combination.

1. An apparatus, comprising:
one or more memories;
one or more transceivers; and
one or more processors communicatively coupled to the one or more memories and the one or more transceivers, the one or more processors, either alone or in combination, configured to:
access, via the one or more transceivers, an email account of a user hosted by one or more remote email servers;
scan the email account of the user to identify a set of service providers from which the email account of the user has received one or more emails;
transmit, via the one or more transceivers, an opt-out request to a service provider of the set of service providers to initiate an opt-out process, wherein the opt-out request comprises an email composed by the apparatus or a webform populated by the apparatus requesting that the service provider delete personal information of the user stored by the service provider, refrain from sharing the personal information of the user with other entities, refrain from selling the personal information of the user with other entities, provide a copy of the personal information of the user that the service provider holds, or any combination thereof;
receive, via the one or more transceivers, from the service provider, an opt-out response to the opt-out request for the opt-out process, wherein the opt-out response includes natural language text indicating a response to the opt-out request;
determine, based on the natural language text indicating the response to the opt-out request, that additional information, additional actions, or a combination thereof are needed to complete the opt-out process;
apply a first machine learning model to the natural language text indicating the response to the opt-out request to generate executable code to input the additional information, perform the additional actions, or the combination thereof; and
execute the executable code to input the additional information, perform the additional actions, or the combination thereof.

2. The apparatus of claim 1, wherein the one or more processors configured to determine that the additional information, the additional actions, or the combination thereof are needed to complete the opt-out process comprise the one or more processors, either alone or in combination, configured to:
apply the first machine learning model to the natural language text indicating the response to the opt-out request to determine that the additional information, the additional actions, or the combination thereof are needed to complete the opt-out process.

3. The apparatus of claim 1, wherein the one or more processors configured to determine that the additional information, the additional actions, or the combination thereof are needed to complete the opt-out process comprise the one or more processors, either alone or in combination, configured to:
apply a second machine learning model to the natural language text indicating the response to the opt-out request to determine that the additional information, the additional actions, or the combination thereof are needed to complete the opt-out process.

4. The apparatus of claim 1, wherein the first machine learning model is a general artificial intelligence model.

5. The apparatus of claim 1, wherein the first machine learning model is iteratively trained on a natural language dataset.

6. The apparatus of claim 1, wherein the opt-out response is:
an email containing the natural language text indicating the response to the opt-out request, or
a webform containing the natural language text indicating the response to the opt-out request.

7. The apparatus of claim 1, wherein:
the opt-out response indicates that the additional information is needed to complete the opt-out process,
the opt-out response includes an email address or a hyperlink to a webform for providing the additional information, and
the one or more processors configured to execute the executable code comprises the one or more processors, either alone or in combination, configured to:
populate the webform with the additional information; or
transmit, via the one or more transceivers, an email including the additional information to the email address.

8. The apparatus of claim 1, wherein:
the opt-out response includes a list of the additional actions needed to complete the opt-out process, and
the one or more processors configured to execute the executable code comprises the one or more processors, either alone or in combination, configured to perform the list of the additional actions needed to complete the opt-out process.

9. The apparatus of claim 1, wherein the one or more processors, either alone or in combination, are further configured to:
receive, via the one or more transceivers, a second opt-out response in response to execution of the executable code, wherein the second opt-out response includes second natural language text indicating a response to the execution of the executable code; and
determine, based on the second natural language text indicating the response to the execution of the executable code, whether the opt-out process is complete.

10. The apparatus of claim 9, wherein the one or more processors, either alone or in combination, are further configured to:
determine, based on the second natural language text indicating the response to the execution of the executable code, that second additional information, second additional actions, or a combination thereof are needed to complete the opt-out process;
apply the first machine learning model to the second natural language text indicating the response to the execution of the executable code to generate second executable code to input the second additional information, perform the second additional actions, or the combination thereof; and
execute the second executable code to input the second additional information, perform the second additional actions, or the combination thereof.

11. The apparatus of claim 1, wherein the one or more processors, either alone or in combination, are further configured to:
receive, via the one or more transceivers, the first machine learning model from a server.

12. The apparatus of claim 1, wherein the one or more processors configured to apply the first machine learning model comprise the one or more processors, either alone or in combination, configured to:
transmit, via the one or more transceivers, the opt-out response to a server implementing the first machine learning model; and
receive, via the one or more transceivers, the executable code from the server.

13. (canceled)

14. (canceled)

15. The apparatus of claim 1, wherein the apparatus is:
a user device of the user, or
a server.

16. A method for completing an opt-out process performed by an apparatus, comprising:
accessing, via one or more transceivers of the apparatus, an email account of a user hosted by one or more remote email servers;
scanning the email account of the user to identify a set of service providers from which the email account of the user has received one or more emails;
transmitting, via the one or more transceivers, an opt-out request to a service provider of the set of service providers to initiate an opt-out process, wherein the opt-out request comprises an email composed by the apparatus or a webform populated by the apparatus requesting that the service provider delete personal information of the user stored by the service provider, refrain from sharing the personal information of the user with other entities, refrain from selling the personal information of the user with other entities, provide a copy of the personal information of the user that the service provider holds, or any combination thereof;
receiving, via the one or more transceivers, from the service provider, an opt-out response to the opt-out request for the opt-out process, wherein the opt-out response includes natural language text indicating a response to the opt-out request;
determining, based on the natural language text indicating the response to the opt-out request, that additional information, additional actions, or a combination thereof are needed to complete the opt-out process;
applying a first machine learning model to the natural language text indicating the response to the opt-out request to generate executable code to input the additional information, perform the additional actions, or the combination thereof; and
executing the executable code to input the additional information, perform the additional actions, or the combination thereof.

17. The method of claim 16, wherein the first machine learning model is iteratively trained on a natural language dataset.

18. The method of claim 16, wherein:
the opt-out response indicates that the additional information is needed to complete the opt-out process,
the opt-out response includes an email address or a hyperlink to a webform for providing the additional information, and
executing the executable code comprises:
populating the webform with the additional information; or
transmitting an email including the additional information to the email address.

19. The method of claim 16, wherein:
the opt-out response includes a list of the additional actions needed to complete the opt-out process, and
executing the executable code comprises performing the list of the additional actions needed to complete the opt-out process.

20. An apparatus, comprising:
means for accessing an email account of a user hosted by one or more remote email servers;
means for scanning the email account of the user to identify a set of service providers from which the email account of the user has received one or more emails;
means for transmitting an opt-out request to a service provider of the set of service providers to initiate an opt-out process, wherein the opt-out request comprises an email composed by the apparatus or a webform populated by the apparatus requesting that the service provider delete personal information of the user stored by the service provider, refrain from sharing the personal information of the user with other entities, refrain from selling the personal information of the user with other entities, provide a copy of the personal information of the user that the service provider holds, or any combination thereof;
means for receiving, from the service provider, the opt-out response to an opt-out request for the opt-out process, wherein the opt-out response includes natural language text indicating a response to the opt-out request;
means for determining, based on the natural language text indicating the response to the opt-out request, that additional information, additional actions, or a combination thereof are needed to complete the opt-out process;
means for applying a first machine learning model to the natural language text indicating the response to the opt-out request to generate executable code to input the additional information, perform the additional actions, or the combination thereof; and
means for executing the executable code to input the additional information, perform the additional actions, or the combination thereof.

21. The apparatus of claim 1, wherein the one or more processors configured to apply the first machine learning model to the natural language text indicating the response to the opt-out request comprises the one or more processors, either alone or in combination, configured to:
generate a prompt instructing the first machine learning model to generate the executable code to input the additional information, perform the additional actions, or the combination thereof based on the natural language text indicating the response to the opt-out request; and
input the prompt to the first machine learning model.

22. The apparatus of claim 1, wherein the first machine learning model is trained on at least a training set of classified opt-out responses and a corresponding reference set of known classification types of opt-out responses.
